(19) United States
(12) Patent Application Publication
(10) Pub. No.: US 2020/0076329 A1
(43) Pub. Date: Mar. 5, 2020

(54) ENERGY COLLECTING DEVICE CAPABLE OF REUSING RESIDUAL CHARGES USING PIEZOELECTRIC ELEMENT

(71) Applicant: CONALOG CO., LTD., Seoul (KR)

(72) Inventor: Eunseo KIM, Seoul (KR)

(21) Appl. No.: 16/675,501

(22) Filed: Nov. 6, 2019

Related U.S. Application Data
(63) Continuation of application No. PCT/KR2018/007600, filed on Jul. 4, 2018.

(30) Foreign Application Priority Data
Jul. 7, 2017 (KR) 10-2017-0086504

(51) Int. Cl. H02N 2/18

(52) U.S. Cl. CPC H02N 2/181; H02N 2/183

(57) ABSTRACT

According to an energy collecting device capable of reusing residual charges using a piezoelectric element proposed in the present invention, the energy collecting device includes the piezoelectric element, a rectifier, a charging/discharging conversion unit, and a digital controller, and a plurality of capacitors included in the charging/discharging conversion unit is converted in a series or parallel connection in a charging mode or a discharging mode, and a connection state of the plurality of capacitors can be converted and connected in one of an entire parallel connection, a partial series connection, and an entire series connection through control of a digital signal in response to a drive voltage for a load to drive under the discharging mode, and thus, it is possible to reuse electric charges remaining in each capacitor to the maximum in response to the drive voltage of the load.

### CROSS-REFERENCE TO RELATED APPLICATIONS

This application is a continuation of International Application No. PCT/KR2018/007600 filed on Jul. 4, 2018 which claims priority to Korean Patent Application No. 10-2017-0086504 filed on Jul. 7, 2017, the entire contents of which are herein incorporated by reference.

### TECHNICAL FIELD

The present invention relates to an energy collecting device, and more specifically, to an energy collecting device capable of reusing residual charges using a piezoelectric element that converts a series or parallel connection state of a plurality of capacitors of a charging/discharging conversion unit in response to a drive voltage for a load to operate such that electric charges remaining in each capacitor can be reused to the maximum in response to a drive voltage for a load to be driven.

### BACKGROUND ART

Recently, there is a growing interest in a wireless switch capable of wirelessly outputting a control signal without using a temporary power supply such as a battery. The wireless switch is also referred to as a batteryless wireless switch (BWS), and since the wireless switch does not require a separate battery or a power supply line for operation of the switch, the wireless switch can reduce installation and maintenance costs.

Such a wireless switch typically adopts a method of collecting electrical energy from a piezoelectric element and adopts a method of rectifying the electrical energy generated by pressing the piezoelectric element, collecting the rectified energy, and transmitting the collected energy to an RF transmission circuit through a regulator. However, this process can result in a significant energy loss, and thus, a configuration capable of minimizing the energy loss is required. In this regard, Korean Patent No. 10-1696427 discloses an energy collecting device including a piezoelectric element switch, a bias flip rectifier, a charging/discharging conversion unit, a controller, and a regulator, and a wireless switch using the same as a prior art document.

A typical energy collecting device disclosed in the prior art document uses a bias flip rectifier including a bridge rectifier, an inductor, and a switching element to improve efficiency of energy transfer at a front end of the charging/discharging conversion unit, and has a problem that a timing control of a bias flip is difficult and a circuit configuration of the charging/discharging conversion unit is also complicated.

### SUMMARY OF INVENTION

### Technical Problem

The present invention is proposed to solve the above-described problems of the conventionally proposed method, and an object of the present invention is to provide an energy collecting device capable of reusing residual charges using a piezoelectric element which includes the piezoelectric element, a rectifier, a charging/discharging conversion unit, and a digital controller, and in which a plurality of capacitors included in the charging/discharging conversion unit is converted in a series connection or a parallel connection in a charging mode or a discharging mode, and a connection state of the plurality of capacitors can be converted and connected in the order of an entire parallel connection, a partial series connection, and an entire series connection through control of a digital signal in response to a drive voltage for a load to drive under the discharging mode, and thus, it is possible to reuse electric charges remaining in each capacitor to the maximum in response to the drive voltage of the load.

Further, another object of the present invention is to provide an energy collecting device capable of reusing residual charges using piezoelectric elements which improves use of electric charges that cannot be used due to not being appropriate for a drive voltage of a load and enables a long term use by changing a connection state of a plurality of capacitors to accumulate electric charges remaining in each capacitor so as to be appropriate for a drive voltage of a load.

In addition, still another object of the present invention is to provide an energy collecting device capable of reusing residual charges using piezoelectric elements which provides a simple circuit structure that improves a complex circuit structure of an existing charging/discharging conversion unit and enables a simple control with a digital signal.

### Solution to Problem

An energy collecting device capable of reusing residual charges using a piezoelectric element as an energy collecting device capable of reusing residual charges using a piezoelectric element includes a piezoelectric element that generates an alternating current according to a pressing operation of a user; a rectifier that rectifies an alternating current generated from the piezoelectric element into a direct current and outputs the direct current; a charging/discharging conversion unit that includes a plurality of capacitors for charging and discharging an output voltage output from the rectifier and converts a connection state of the plurality of capacitors into a series or parallel connection to control charging and discharging of energy; and a digital controller that outputs a switching control signal for controlling charging and discharging of the plurality of capacitors provided in the charging/discharging conversion unit. In the charging/discharging conversion unit, the plurality of capacitors are all connected in series on the basis of the switching control signal of the digital controller, in a charging mode of the plurality of capacitors, and connection states of the plurality of capacitors are converted and connected in one of an entire parallel connection, a partial series connection, and an entire series connection on the basis of the switching control signal of the digital controller corresponding to a drive voltage for a load to operate in a discharging mode of the plurality of capacitors.

Preferably, the rectifier may be configured with a bridge diode including four diodes.

Preferably, the charging/discharging conversion unit may be configured to increase the plurality of capacitors by a multiple of 2.

Preferably, the charging/discharging conversion unit is configured to may include first to fourth capacitors, each having one terminal connected in parallel to an output terminal of the rectifier; first to third diodes connected in parallel between each one terminal of the second to fourth capacitors and the output terminal of the rectifier; a first switching element which is connected between the other terminal of the first capacitor and a ground terminal, is connected to a connection node between the first diode and the second capacitor, and is switched according to the switching control signal of the digital controller; a second switching element which is connected between the other terminal of the second capacitor and the ground terminal, is connected to a connection node between the second diode and the third capacitor, and is switched according to the switching control signal of the digital controller; and a third switching element which is connected between the other terminal of the third capacitor and the ground terminal, is connected to a connection node between the third diode and the fourth capacitor, and is switched according to the switching control signal of the digital controller.

More preferably, each of the first to third switching elements may be configured with a CMOS (Complementary Metal-Oxide Semiconductor) switch which is configured with a p-channel MOS transistor and an n-channel MOS transistor and in which both transistors operate complementarily, or is configured with a MOSFET switch which is configured with any one pair of NMOS transistors and PMOS transistors and in which both transistors operate complementarily.

More preferably, each of the first to third switching elements may include the n-channel MOS transistor connected between the capacitor and the ground terminal, and the p-channel MOS transistor connected between the capacitor and a connection node between the diode connected in parallel in the next stage and another capacitor.

More preferably, the digital controller may output a digital signal of “1 or 0” to the first to third switching elements as the switching control signal, and in a charging mode of the charging/discharging conversion unit, the digital controller may output the digital signal for making all the switching control signals become “0” to the first to third switching elements to control such that the first to fourth capacitors are connected in series to be charged, and in a discharging mode of the charging/discharging conversion unit, the digital controller may output the digital signal for making all the switching control signals become “1” to the first to third switching elements to control such that the first to fourth capacitors are connected in parallel to output a drive voltage for a load to operate.

More preferably, under an operation of a parallel connection in all the discharging modes of the charging/discharging conversion unit, in a case where output voltages of the first to fourth capacitors are less than or equal to the drive voltage for the load to operate, the digital controller may output the digital signal of “0” to the first and third switching elements to control such that the first to fourth capacitors are connected in partial series to output the drive voltage for the load to operate, and in an operation state of the partial series connection of the discharging mode of the charging/discharging conversion unit, in a case where the output voltages of the first to fourth capacitors are lower than or equal to the drive voltage for the load to operate, the digital controller may output the digital signal of “0” to the second switching element to control such that the first to fourth capacitors are all connected in series to output the drive voltage for the load to operate.

### Advantageous Effects of Invention

According to an energy collecting device capable of reusing residual charges using a piezoelectric element proposed by the present invention, the energy collecting device include the piezoelectric element, a rectifier, a charging/discharging conversion unit, and a digital controller, and a plurality of capacitors included in the charging/discharging conversion unit is converted in a series connection or a parallel connection in a charging mode or a discharging mode, and a connection state of the plurality of capacitors can be converted and connected in the order of an entire parallel connection, a partial series connection, and an entire series connection through control of a digital signal in response to a drive voltage for a load to drive under the discharging mode, and thus, it is possible to reuse electric charges remaining in each capacitor to the maximum in response to the drive voltage of the load.

Further, according to the present invention, by changing a connection state of a plurality of capacitors to accumulate electric charges remaining in each capacitor so as to be appropriate for a drive voltage of a load, it is possible to improve use of electric charges that cannot be used due to not being appropriate for a drive voltage of a load and to enable a long term use.

In addition, the present invention provides a simple circuit structure that improves a complex circuit structure of an existing charging/discharging conversion unit and enables a simple control with a digital signal.

### BRIEF DESCRIPTION OF DRAWINGS

FIG. 1 is a functional block diagram illustrating a configuration of an energy collecting device capable of reusing residual charges using a piezoelectric element according to an embodiment of the present invention.

FIG. 2 is a diagram illustrating an entire circuit configuration of an energy collecting device capable of reusing the residual charges using the piezoelectric element according to the embodiment of the present invention.

FIG. 3A is a diagram illustrating a circuit configuration of a charging/discharging conversion unit of the energy collecting device capable of reusing the residual charges using the piezoelectric element according to the embodiment of the present invention.

FIG. 3B is a diagram illustrating a circuit configuration of a charging/discharging conversion unit of the energy collecting device capable of reusing the residual charges using the piezoelectric element according to the embodiment of the present invention.

FIG. 4 is a diagram illustrating a switching control signal of a digital controller of the energy collecting device capable of reusing the residual charges using the piezoelectric element according to the embodiment of the present invention.

FIG. 5A is a diagram illustrating a series or parallel connection state of capacitors included in the charging/discharging conversion unit of the energy collecting device capable of reusing the residual charges using the piezoelectric element according to the embodiment of the present invention.

FIG. 5B is a diagram illustrating a series or parallel connection state of capacitors included in the charging/discharging conversion unit of the energy collecting device capable of reusing the residual charges using the piezoelectric element according to the embodiment of the present invention.

FIG. 5C is a diagram illustrating a series or parallel connection state of capacitors included in the charging/discharging conversion unit of the energy collecting device capable of reusing the residual charges using the piezoelectric element according to the embodiment of the present invention.

FIG. 5D is a diagram illustrating a series or parallel connection state of capacitors included in the charging/discharging conversion unit of the energy collecting device capable of reusing the residual charges using the piezoelectric element according to the embodiment of the present invention.

### DETAILED DESCRIPTION

Hereinafter, preferred embodiments will be described in detail with reference to the accompanying drawings such that those skilled in the art may easily implement the present invention. However, in describing the preferred embodiment of the present invention in detail, in a case where it is determined that specific description on a related known function or configuration may unnecessarily obscure a subject matter of the present invention, detailed description thereof will be omitted. Further, the same reference numeral is used for a portion having similar function and action throughout the drawings.

In addition, throughout the specification, when a portion is “connected” to another portion, which includes not only a case where the portion is “directly connected” but also a case where the portion is “indirectly connected” with another element therebetween. Further, the term “including” a certain configuration element means that another configuration element is not excluded and may be further included unless described otherwise.

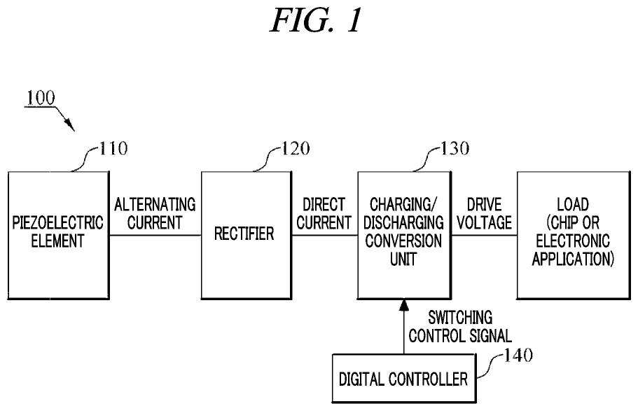

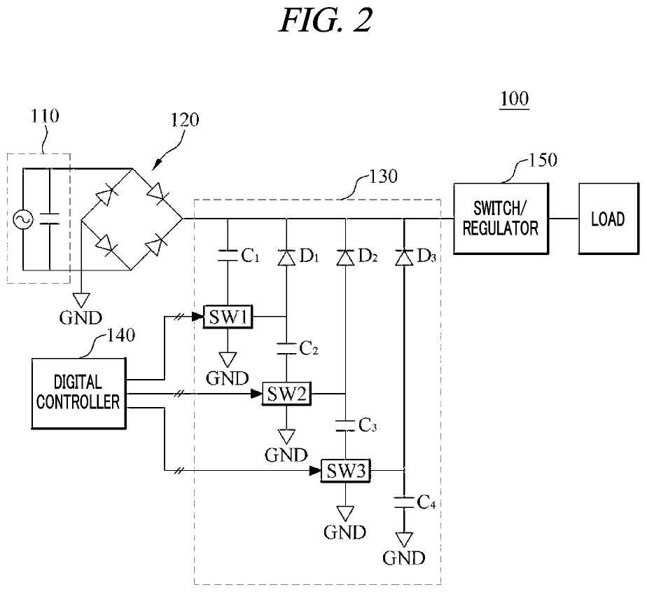

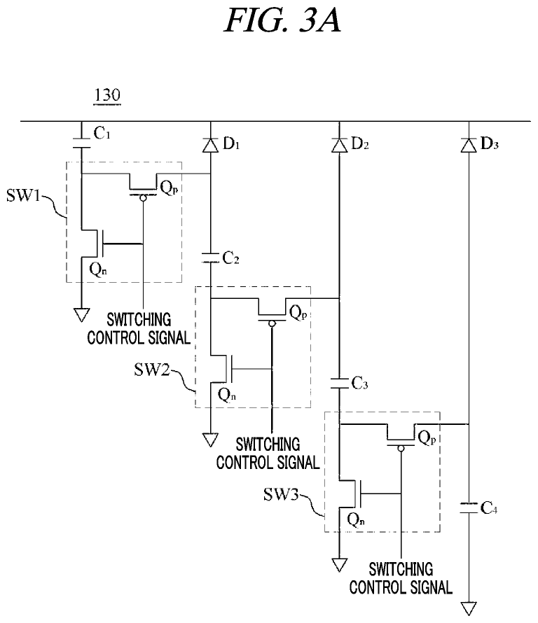

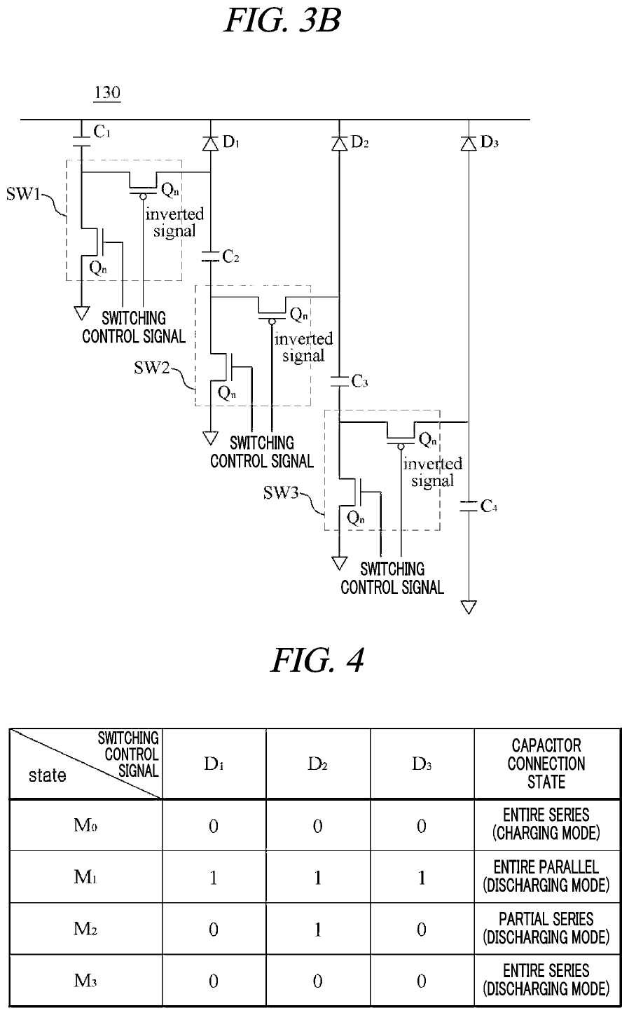

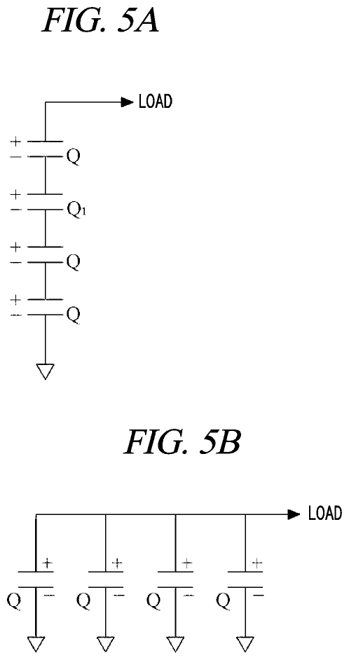

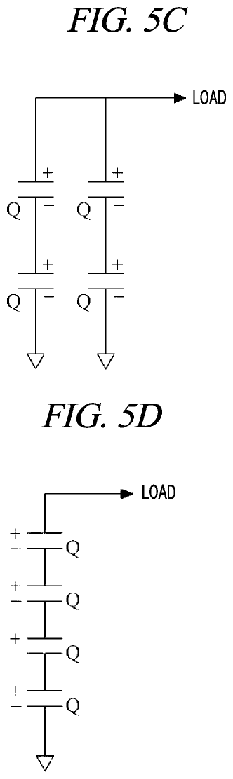

FIG. 1 is a functional block diagram illustrating a configuration of an energy collecting device capable of reusing residual charges using a piezoelectric element according to an embodiment of the present invention, FIG. 2 is a diagram illustrating an entire circuit configuration of an energy collecting device capable of reusing the residual charges using the piezoelectric element according to the embodiment of the present invention, FIG. 3A is a diagram illustrating a circuit configuration of a charging conversion unit of the energy collecting device capable of reusing the residual charges using the piezoelectric element according to the embodiment of the present invention, FIG. 3B is a diagram illustrating a circuit configuration of a charging/discharging conversion unit of the energy collecting device capable of reusing the residual charges using the piezoelectric element according to the embodiment of the present invention, FIG. 4 is a diagram illustrating a switching control signal of a digital controller of the energy collecting device capable of reusing the residual charges using the piezoelectric element according to the embodiment of the present invention, FIG. 5A is a diagram illustrating a series or parallel connection state of capacitors included in the charging/discharging conversion unit of the energy collecting device capable of reusing the residual charges using the piezoelectric element according to the embodiment of the present invention, FIG. 5B is a diagram illustrating a series or parallel connection state of capacitors included in the charging/discharging conversion unit of the energy collecting device capable of reusing the residual charges using the piezoelectric element according to the embodiment of the present invention, FIG. 5C is a diagram illustrating a series or parallel connection state of capacitors included in the charging/discharging conversion unit of the energy collecting device capable of reusing the residual charges using the piezoelectric element according to the embodiment of the present invention, and FIG. 5D is a diagram illustrating a series or parallel connection state of capacitors included in the charging/discharging conversion unit of the energy collecting device capable of reusing the residual charges using the piezoelectric element according to the embodiment of the present invention. As illustrated in FIGS. 1 to 3, an energy collecting device 100 capable of reusing the residual charges using the piezoelectric element according to the embodiment of the present invention can be configured to include a piezoelectric element 110, a rectifier 120, a charging/discharging conversion unit 130, and a digital controller 140.

The piezoelectric element 110 is configured to generate an alternating current according to a pressing operation of a user. The piezoelectric element 110 converts a pressure applied dynamically into a voltage and generates the alternating current according to the pressing operation of the user on the piezoelectric element 110 and outputs the alternating current. Here, since a configuration of the piezoelectric element 110 corresponds to a general configuration, unnecessary description thereof will be omitted.

The rectifier 120 rectifies is configured to rectify the alternating current generated from the piezoelectric element 110 into a direct current and output the direct current. The rectifier 120 can be configured with a bridge diode (BD) including four diodes, as illustrated in FIG. 2.

The charging/discharging conversion unit 130 has a circuit configuration which includes a plurality of capacitors for charging and discharging an output voltage output from the rectifier 120, converts a connection state of a plurality of capacitors into a series connection state or a parallel connection state, and adjusts charging and discharging of energy. The charging/discharging conversion unit 130 can be realized such that in a charging mode of the plurality of capacitors, the plurality of capacitors are all connected in series based on a switching control signal of the digital controller 140 which will be described below, and in a discharging mode of the plurality of capacitors, connection states of the plurality of capacitors are converted and connected in the order of an entire parallel connection, a partial series connection, and an entire series connection on the basis of the switching control signal of the digital controller 140 corresponding to a drive voltage for a load to operate. Here, the charging/discharging conversion unit 130 can be realized to increase the plurality of capacitors by a multiple of 2. At this time, a configuration of a diode and a switch may be increased according to expansion of the plurality of capacitors. Further, the charging/discharging conversion unit 130 can be connected to a switch/regulator 150 whose switch or regulator is connected to an output connected to a load. Here, the switch/regulator 150 may perform a function of switching or voltage regulation to prevent an internal element from being damaged due to a high voltage in an actual circuit realization.

Further, as illustrated in FIGS. 2 and 3, the charging/discharging conversion unit 130 can be configured to include first to fourth capacitors C1 to C4, each having one terminal connected to an output terminal of the rectifier 120, first to third diodes D1 to D3 connected in parallel between each one terminal of the second to fourth capacitors C2 to C4 and the output terminal of the rectifier 120, a first switching element which is connected between the other terminal of the first capacitor C1 and a ground terminal, is connected to a connection node between the first diode D1 and the second capacitor C2, and is switched according to a switching control signal of the digital controller 140, a second switching element SW2 which is connected between the other terminal of the second capacitor C2 and the ground terminal, is connected to a connection node between the second diode D2 and the third capacitor C3, and is switched according to the switching control signal of the digital controller 140, and a third switching element SW3 which is connected between the other terminal of the third capacitor C3 and the ground terminal, is connected to a connection node between the third diode D3 and the fourth capacitor C4, and is switched according to the switching control signal of the digital controller 140.

As illustrated in FIG. 3A, each of the first to third switching elements SW1 to SW3 can be configured with a CMOS (Complementary Metal-Oxide Semiconductor) switch which is realized by a p-channel MOS transistor Qp and an n-channel MOS transistor Qn and in which both transistors operate complementarily. Each of the first to third switching elements SW1 to SW3 includes the n-channel MOS transistor Qn connected between the capacitor and the ground terminal to be switched, and the p-channel MOS transistor Qp connected between the capacitor and the connection node between the diode and the capacitor connected in parallel in the next stage. Here, the first to third switching elements SW1 to SW3 can be configured with a switch in which two switches are configured as one module and are switched in opposite directions to set a path, instead of the CMOS switch. That is, each of the first to third switching elements SW1 to SW3 can also be configured with a MOSFET switch which is configured by any one pair of NMOS transistors and PMOS transistors and in which both transistors operate complementarily. At this time, FIG. 3B illustrates an implementation example of an example of a MOSFET switch in which each of the first to third switching elements SW1 to SW3 has a pair of NMOS and both transistors operate complementarily. That is, among the NMOS switches implemented in pair in each of the first to third switching elements SW1 to SW3 in FIG. 3B, a circle display can be regarded as an inverted signal, and a circle displayed on an actual logic gate can be interpreted as a configuration to which an inverter is connected or an inverted signal.

The digital controller 140 is a configuration of a controller that outputs a switching control signal for controlling charging and discharging of a plurality of capacitors included in the charging/discharging conversion unit 130. The digital controller 140 outputs a digital signal of “1 or 0” to the first to third switching elements SW1 to SW3 as a switching control signal, and in a charging mode of the charging/discharging conversion unit 130, the digital controller 140 outputs a digital signal for making all the switching control signals become “0” to the first to third switching elements SW1 to SW3 as illustrated in FIG. 4 to control such that the first to fourth capacitors C1 to C4 are connected in series to be charged as illustrated in FIG. 5A, and in a discharging mode of the charging/discharging conversion unit 130, the digital controller 140 outputs a digital signal for making all the switching control signals become “1” to the first to third switching elements SW1 to SW3 as illustrated in FIG. 4 to control such that the first to fourth capacitors C1 to C4 are connected in parallel to output a drive voltage for a load to operate as illustrated in FIG. 5B.

Further, under an operation of a parallel connection in all the discharging modes of the charging/discharging conversion unit 130, in a case where output voltages of the first to fourth capacitors C1 to C4 are less than or equal to the drive voltage for the load to operate, the digital controller 140 outputs the digital signal of “0” to the first and third switching elements SW1 and SW3 as illustrated in FIG. 4 to control such that the first to fourth capacitors C1 to C4 are connected in partial series to output the drive voltage for the load to operate as illustrated in FIG. 5C.

Further, in the operation state of the partial series connection of the discharging mode of the charging/discharging conversion unit 130, in a case where the output voltages of the first to fourth capacitors C1 to C4 are lower than or equal to the drive voltage for the load to operate, the digital controller 140 outputs the digital signal of “0” to the second switching element SW2 as illustrated in FIG. 4 to control such that the first to fourth capacitors C1 to C4 are all connected in series to output the drive voltage for the load to operate as illustrated in of FIG. 5D.

FIG. 4 illustrates the switching control signal of the digital controller of the energy collecting device capable of reusing the residual charges using the piezoelectric element according to the embodiment of the present invention. FIG. 4 illustrates a digital signal applied to gate terminals of the first to third switching elements SW1 to SW3 of the charging/discharging conversion unit 130 and a connection state of the first to fourth capacitors C1 to C4 according to application of the digital signal, in a table.

FIG. 5A to 5D illustrates a series or parallel connection state of the capacitors included in the charging/discharging conversion unit of the energy collecting device capable of reusing the residual charges using the piezoelectric element according to the embodiment of the present invention. FIG. 5A illustrates capacitor series connection when the first to fourth capacitors C1 to C4 of the charging/discharging conversion unit 130 are first accumulated with electric charges, and FIG. 5b to FIG. 5D illustrate a parallel connection, a partial series connection, and a series connection of the capacitors when the electric charges accumulated in the first to fourth capacitors C1 to C4 of the charging/discharging conversion unit 130 are discharged. FIG. 5B illustrates a state in which the first to fourth capacitors C1 to C4 are connected in parallel to supply a drive voltage when the being higher than the drive voltage of the load, FIG. 5C illustrates a state in which the first to fourth capacitors C1 to C4 are connected in partial series to supply the drive voltage such that when the voltage is lower than the drive voltage of the load, the residual charges that cannot be used are collected and the voltage is increased to supply a drive power, and FIG. 5D illustrates a state in which the first to fourth capacitors C1 to C4 are all connected in series to supply the drive voltage such that when the voltage is lower than the drive voltage of the load even under a partial series connection, the residual charges that cannot be used are collected and the voltage is increased to supply the drive power.

As described above, an energy collecting device capable of reusing residual charges using a piezoelectric element according to an embodiment of the present invention includes the piezoelectric element, a rectifier, a charging/discharging conversion unit, and a digital controller, and a plurality of capacitors included in the charging/discharging conversion unit is converted in a series connection or a parallel connection in a charging mode or a discharging mode, and a connection state of the plurality of capacitors can be converted and connected in the order of an entire parallel connection, a partial series connection, and an entire series connection through control of a digital signal in response to a drive voltage for a load to drive under the discharging mode, and thus, it is possible to reuse electric charges remaining in each capacitor to the maximum in response to the drive voltage of the load and to improve use of electric charges that cannot be used due to not being appropriate for the drive voltage of the load, and to use for a long time. Further, a simple circuit structure that improves a complex circuit structure of the existing charging/discharging conversion unit is provided, and a simple control is possible with a digital signal.

The present invention described above can be variously modified or applied by those skilled in the art to which the present invention belongs, and the scope of the technical idea according to the present invention should be defined by the following claims.

What is claimed is:

1. An energy collecting device capable of reusing residual charges using a piezoelectric element as an energy collecting device capable of reusing residual charges using a piezoelectric element, comprising:
a piezoelectric element that generates an alternating current according to a pressing operation of a user;
a rectifier that rectifies an alternating current generated from the piezoelectric element into a direct current and outputs the direct current;
a charging/discharging conversion unit that includes a plurality of capacitors for charging and discharging an output voltage output from the rectifier and converts a connection state of the plurality of capacitors into a series or parallel connection to control charging and discharging of energy; and
a digital controller that outputs a switching control signal for controlling charging and discharging of the plurality of capacitors provided in the charging/discharging conversion unit,
wherein, in a charging mode of the plurality of capacitors, the plurality of capacitors are all connected in series on the basis of the switching control signal of the digital controller, and
in a discharging mode of the plurality of capacitors, connection states of the plurality of capacitors are converted and connected in one of an entire parallel connection, a partial series connection, and an entire series connection on the basis of the switching control signal of the digital controller corresponding to a drive voltage for a load to operate.

2. The energy collecting device capable of reusing residual charges using the piezoelectric element according to claim 1, wherein the rectifier is configured with a bridge diode (BD) including four diodes.

3. The energy collecting device capable of reusing residual charges using the piezoelectric element according to claim 1, wherein the charging/discharging conversion unit is configured to increase the plurality of capacitors by a multiple of 2.

4. The energy collecting device capable of reusing residual charges using the piezoelectric element according to claim 1, wherein the charging/discharging conversion unit is configured to include
first to fourth capacitors C1 to C4, each having one terminal connected in parallel to an output terminal of the rectifier;
first to third diodes D1 to D3 connected in parallel between each one terminal of the second to fourth capacitors C2 to C4 and the output terminal of the rectifier;
a first switching element SW1 which is connected between the other terminal of the first capacitor C1 and a ground terminal, is connected to a connection node between the first diode D1 and the second capacitor C2, and is switched according to the switching control signal of the digital controller;
a second switching element SW2 which is connected between the other terminal of the second capacitor C2 and the ground terminal, is connected to a connection node between the second diode D2 and the third capacitor C3, and is switched according to the switching control signal of the digital controller; and
a third switching element SW3 which is connected between the other terminal of the third capacitor C3 and the ground terminal, is connected to a connection node between the third diode D3 and the fourth capacitor C4, and is switched according to the switching control signal of the digital controller.

5. The energy collecting device capable of reusing residual charges using the piezoelectric element according to claim 4, wherein each of the first to third switching elements SW1 to SW3 is configured with a CMOS (Complementary Metal-Oxide Semiconductor) switch which is configured with a p-channel MOS transistor Qp and an n-channel MOS transistor Qn and in which both transistors operate complementarily, or is configured with a MOSFET switch which is configured with any one pair of NMOS transistors and PMOS transistors and in which both transistors operate complementarily.

6. The energy collecting device capable of reusing residual charges using the piezoelectric element according to claim 5, wherein each of the first to third switching elements SW1 to SW3 includes the n-channel MOS transistor Qn connected between the capacitor and the ground terminal, and the p-channel MOS transistor Qp connected between the capacitor and a connection node between the diode connected in parallel in the next stage and another capacitor.

7. The energy collecting device capable of reusing residual charges using the piezoelectric element according to claim 4,
wherein the digital controller outputs a digital signal of “1 or 0” to the first to third switching elements SW1 to SW3 as the switching control signal,
wherein in a charging mode of the charging/discharging conversion unit, the digital controller outputs the digital signal for making all the switching control signals become “0” to the first to third switching elements SW1 to SW3 to control such that the first to fourth capacitors C1 to C4 are connected in series to be charged, and
wherein in a discharging mode of the charging/discharging conversion unit, the digital controller outputs the digital signal for making all the switching control signals become “1” to the first to third switching elements SW1 to SW3 to control such that the first to fourth capacitors C1 to C4 are connected in parallel to output a drive voltage for a load to operate.

8. The energy collecting device capable of reusing residual charges using the piezoelectric element according to claim 7,
wherein under an operation of a parallel connection in all the discharging modes of the charging/discharging conversion unit, in a case where output voltages of the first to fourth capacitors C1 to C4 are less than or equal to the drive voltage for the load to operate, the digital controller outputs the digital signal of “0” to the first and third switching elements SW1 and SW3 to control such that the first to fourth capacitors C1 to C4 are connected in partial series to output the drive voltage for the load to operate, and
wherein in an operation state of the partial series connection of the discharging mode of the charging/discharging conversion unit, in a case where the output voltages of the first to fourth capacitors C1 to C4 are lower than or equal to the drive voltage for the load to operate, the digital controller outputs the digital signal of “0” to the second switching element SW2 to control such that the first to fourth capacitors C1 to C4 are all connected in series to output the drive voltage for the load to operate.

9. The energy collecting device capable of reusing residual charges using the piezoelectric element according to claim 1,
wherein, in a discharging mode of the plurality of capacitors, connection states of the plurality of capacitors are converted and connected in an order of an entire parallel connection, a partial series connection, and an entire series connection on the basis of the switching control signal of the digital controller corresponding to a drive voltage for a load to operate.
